(19) United States
(12) Patent Application Publication
(10) Pub. No.: US 2010/0313185 A1
(43) Pub. Date: Dec. 9, 2010

(54) ACCESS TO TEST-READY VIRTUAL ENVIRONMENTS

(75) Inventors: Amit Gupta, Hyderabad (IN); Anurag Gupta, Hyderabad (IN); Aseem Bansal, Hyderabad (IN); Darshan Deepak Desai, Andha Pradesh (IN); Sravanthi Sai Krishna Rajanala, Hyderabad (IN); Sriram Dhanasekaran, Hyderabad (IN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/477,147

(22) Filed: Jun. 3, 2009

(51) Int. Cl. G06F 11/36; G06F 17/30; G06F 9/445; G06F 9/455

(52) U.S. Cl. 717/124; 717/174; 718/1; 707/E17.005

(57) ABSTRACT

Aspects of the subject matter described herein relate to test-ready virtual environments. In aspects, a lab environment may be configured that includes multiple virtual machines. The virtual machines may be configured with deployment agents that can be used to install and configure programs on the virtual machines. The virtual machines may also be configured with test agents that can engage in testing activities with respect to the virtual machines. Lab agents may be installed in the virtual machines that manage and monitor the health of the deployment and test agents. Components are described that control configuring the virtual machines of the lab environment into a known state that is ready for development or testing. Various applications of the above are also described.

### BACKGROUND

Today, software products often involve many components that may be distributed over multiple machines. A change in one of the software components may inadvertently break the functionality in other software components. To test and develop these software products, an environment may be manually set up that includes the various components. Unfortunately, setting up such an environment is difficult and error prone.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Briefly, aspects of the subject matter described herein relate to test-ready virtual environments. In aspects, a lab environment may be configured that includes multiple virtual machines. The virtual machines may be configured with deployment agents that can be used to install and configure programs on the virtual machines. The virtual machines may also be configured with test agents that can engage in testing activities with respect to the virtual machines. Lab agents may be installed in the virtual machines that manage and monitor the health of the deployment and test agents. Components are described that control configuring the virtual machines of the lab environment into a known state that is ready for development or testing. Various applications of the above are also described.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” is to be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary general-purpose computing environment into which aspects of the subject matter described herein may be incorporated;

FIG. 2 is a block diagram representing an exemplary environment in which aspects of the subject matter described herein may be implemented;

FIG. 3 is a block diagram that generally represents exemplary actions that may occur in accordance with aspects of the subject matter described herein;

FIG. 4 is a block diagram that generally represents exemplary actions that may occur in testing a change to source code in accordance with aspects of the subject matter described herein;

FIG. 5 is a block diagram that generally represents exemplary actions that may occur in testing a new build in accordance with aspects of the subject matter described herein; and

FIG. 6 is a block diagram that generally represents exemplary actions that may occur in providing access to a development tool to a virtual environment in accordance with aspects of the subject matter described herein.

### DETAILED DESCRIPTION

### Definitions

As used herein, the term “includes” and its variants are to be read as open-ended terms that mean “includes, but is not limited to.” The term “or” is to be read as “and/or” unless the context clearly dictates otherwise. The term “based on” is to be read as “based at least in part on.” Other definitions, explicit and implicit, may be included below.

### Exemplary Operating Environment

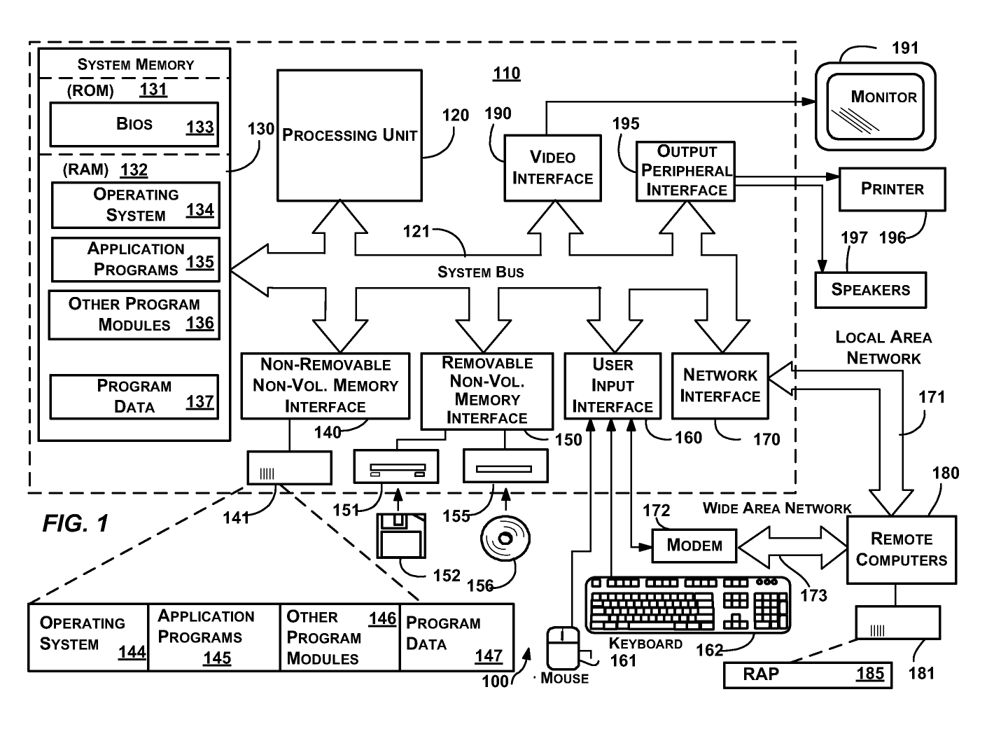

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well known computing systems, environments, or configurations that may be suitable for use with aspects of the subject matter described herein comprise personal computers, server computers, hand-held or laptop devices, multiprocessor systems, microcontroller-based systems, set-top boxes, programmable consumer electronics, network PCs, minicomputers, mainframe computers, personal digital assistants (PDAs), gaming devices, printers, appliances including set-top, media center, or other appliances, automobile-embedded or attached computing devices, other mobile devices, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. A computer may include any electronic device that is capable of executing an instruction. Components of the computer 110 may include a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, Peripheral Component Interconnect Extended (PCI-X) bus, Advanced Graphics Port (AGP), and PCI express (PCIe).

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media.

Computer storage media includes both volatile and nonvolatile, removable and non-removable media implemented in any method or technology for storage of information such as computer-readable instructions, data structures, program modules, or other data. Computer storage media includes RAM, ROM, EEPROM, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include magnetic tape cassettes, flash memory cards, digital versatile discs, other optical discs, digital video tape, solid state RAM, solid state ROM, and the like. The hard disk drive 141 is typically connected to the system bus through a non-removable memory interface such as interface 140, and magnetic disk drive 151 and optical disc drive 155 are typically connected to the system bus by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies.

A user may enter commands and information into the computer 20 through input devices such as a keyboard 162 and pointing device 161, commonly referred to as a mouse, trackball, or touch pad. Other input devices (not shown) may include a microphone, joystick, game pad, satellite dish, scanner, a touch-sensitive screen, a writing tablet, or the like. These and other input devices are often connected to the processing unit 120 through a user input interface 160 that is coupled to the system bus, but may be connected by other interface and bus structures, such as a parallel port, game port or a universal serial bus (USB).

A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets, and the Internet.

When used in a LAN networking environment, the computer 110 is connected to the LAN 171 through a network interface or adapter 170. When used in a WAN networking environment, the computer 110 may include a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Virtual Environments

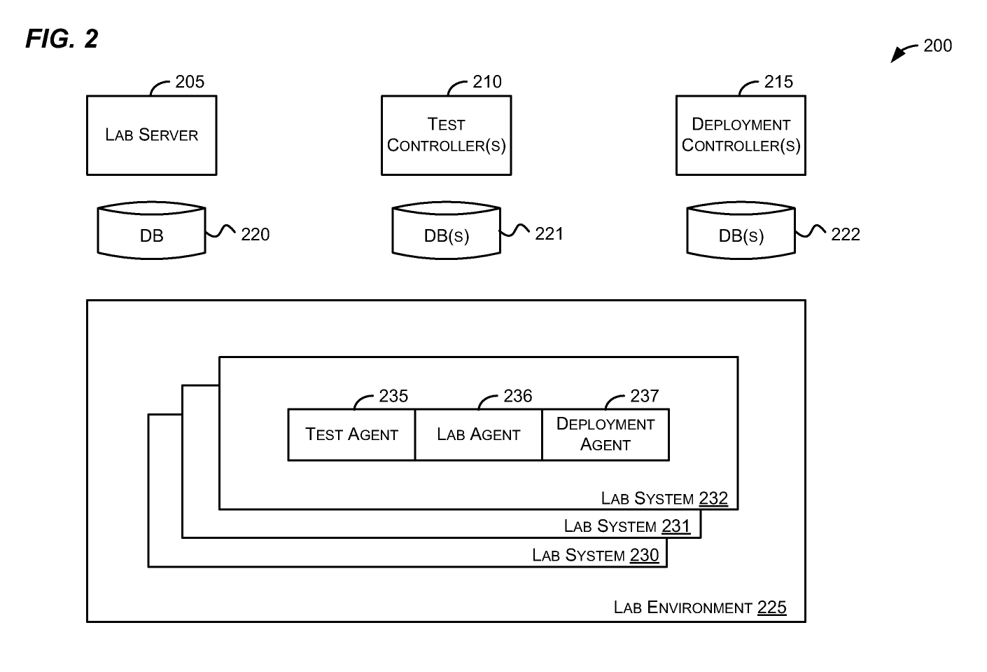

As mentioned previously, setting up environments to develop and test software is difficult and error prone. FIG. 2 is a block diagram representing an exemplary environment in which aspects of the subject matter described herein may be implemented. The environment 200 may include a lab server 205, one or more test controllers 210, one or more deployment controllers 215, a lab environment 225, and may include other entities (not shown). The lab environment 225 may include one or more lab systems 230-232. Each lab system may include a test agent (e.g., the test agent 235), a lab agent (e.g., the lab agent 236), and a deployment agent (e.g., the deployment agent 237).

The various entities illustrated in FIG. 2 may be located relatively close to each other or may be distributed throughout the world. The various entities may communicate with each other via one or more local area networks, wide area networks, direct connections, virtual connections, private networks, virtual private networks, inter- and intra-process communication channels, shared memory, some combination of the above, and the like.

Each of the various entities may be implemented as one or more components. As used herein, the term component is to be read to include all or a portion of a device, one or more software components executing on one or more devices (e.g., the computer 110 of FIG. 1), some combination of one or more software components and one or more devices, and the like.

One or more of the entities may be implemented in a virtual machine. A virtual machine may simulate or emulate a physical machine. A virtual machine is a machine that, to software executing on the virtual machine, appears to be a physical machine. The software may save files in a virtual storage device such as virtual hard drive, virtual floppy disk, and the like, may read files from a virtual CD, may communicate via a virtual network adapter, and so forth.

More than one virtual machine may be hosted on a single computer. That is, two or more virtual machines may execute on a single physical computer. To software executing in each virtual machine, the virtual machine may appear to have its own hardware even though the virtual machines hosted on a single computer may physically share one or more physical devices with each other and with the hosting operating system.

The lab server 205 may host a lab service that manages a set of virtual machines that are grouped into a lab environment (e.g., the lab environment 225). A lab environment is sometimes referred to herein as a virtual environment. The lab service may integrate the usage of lab environments with application lifetime management life cycles.

A lab system (e.g., such as the lab systems 230-232) is a virtual machine that is managed by the lab service. A lab system may be stored in a library, deployed onto a host, or otherwise situated. A lab system may participate in one or more roles (e.g., Web server, database, middle tier, application server, security, name server, other roles, and the like) within an environment. The terms virtual machine and lab system are used interchangeably.

A lab environment (e.g., the lab environment 225) is a logical grouping of one or more lab systems. Lab systems within a lab environment may be deployed, started, stopped, and otherwise operated on as a unit. The lab systems within a lab environment provide an environment for executing programs inside virtual machines. At least two of the programs in a lab environment may communicate with each other during execution.

A lab environment template is a logical grouping of one or more lab systems stored in a library. A lab environment template represents a definition of the environment that can be shared by multiple users to create similar copies of the environment.

A test agent (e.g., the test agent 235) is a program that is operable to execute inside of a lab system. Where multiple lab systems are part of a lab environment, each lab system may include (or be associated with) its own test agent. This program may execute a testing activity. A testing activity may include executing one or more tests, collecting logs of applications and other programs that run on the lab system, extracting information from the logs, responding to other requests from a test controller, and the like.

A test controller (e.g., each of the test controller(s) 210) is a program that executes outside a lab environment and manages test agents that run on the lab systems of the lab environment. A test controller may execute in a virtual machine or a physical machine. A test controller may send requests to collect logs as well as requests to execute test to the test agents that run on the lab systems of a lab environment. In an embodiment, there may be one test controller for each lab environment.

A deployment workflow is used to execute deployment activities on various machines corresponding to lab systems. Deployment activities may be executed in parallel across lab systems.

A deployment agent (e.g., the deployment agent 237) may comprise a program installed on a lab system. The deployment agent is operable to execute inside the lab system. Where multiple lab systems are part of a lab environment, each lab system may include (or be associated with) its own deployment agent. A deployment agent may execute a deployment activity (e.g., installing an application, configuring an application, and so forth) upon receiving a request from a deployment controller.

A deployment controller (e.g., the deployment controller 215) may comprise a program that manages deployment agents running on lab systems. A deployment controller may execute on a machine inside or outside of a lab environment. A deployment controller may execute a deployment workflow and send requests to execute various actions to various deployment agents executing in various lab systems of a lab environment. In an embodiment, there may be one deployment controller for each lab environment.

A lab agent (e.g., the lab agent 236) may comprise a program installed on a lab system. A lab agent may be responsible for installing, configuring, and monitoring test and deployment agent(s).

A data exchange component enables transfer of data from a host machine to a virtual machine and vice-versa. In some virtual environments, the virtual environment may provide a key/value pair exchange component to transfer key/value pairs from the host machine to the virtual machine and vice versa. This component may be installed in a virtual machine to allow this exchange.

In other environments, variables may be used to transfer data from a host to the virtual machine and vice-versa. Transferring data in this way may involve first installing a component in the virtual machine.

In some virtual environments, shared memory, network connections, inter- and intra-process communication channels, or other communications mechanisms may be used to communicate between a virtual machine and a host of the virtual machine.

The environments in which applications are deployed are getting more and more complex. For example, a server application may include multiple tiers. Each tier may have its own set of prerequisites and may be deployed on a single machine or multiple machines. For example, a relational database tier may need one or more components of a database server to be installed as a prerequisite. These prerequisites may be pre-installed on a hard disk image of the lab system. The application roles that are hosted on a lab system in context of an application deployment topology may be stored in metadata of the lab system.

One may compose complex lab environment templates by selecting lab systems stored in a library. As mentioned previously, these lab environment templates may be used to generate similar multiple lab environments to be used by different users.

Another way to bring an existing environment to a state with only prerequisites installed or to another known state is by using snapshots. When a snapshot of an environment is taken, the state of one or more machines in the environment may be captured as of the time of the snapshot. The environment may then be reverted to a snapshot to bring it to a known state (e.g., before/after prerequisites were installed, after a specific version of an application was installed, after a bug was found during testing of an application, and the like).

To prepare a lab environment to deploy an application, a new build of an application, or run tests, may involve installing or configuring testing and deployment components.

Test infrastructure components for a lab environment include a test controller and test agents. Test agents may be installed on one or more lab systems. Similarly, the deployment infrastructure components of a lab environment include a deployment controller and one or more deployment agents. The deployment controller may be outside of the lab environment while the deployment agents may be installed on one or more of the lab systems. The configuration of these components may involve configuring the agent component(s) as well as controller component(s).

The configuration of these components may be stored in the metadata associated with a lab environment or lab system. A user may indicate the configuration when creating a definition of the environment, for example. Configurations may be applied on both controllers and agents.

To configure agent components, the lab server 205 may send agent configuration data to a lab system that includes the agents. In an embodiment, the configuration data may be sent using data exchange component that enables transfer of data from a host machine to a virtual machine and vice-versa as described previously. In some implementations, sending the data through such a data exchange component may allow the lab server 205 to send the data without having any specific access rights on the lab system.

Some data exchange components may be available only when an underlying virtualization component is installed on a lab system. In these environments, during creation of each lab system on a host machine, the lab server 205 may install the virtualization component as well.

After installing these virtualization components, the lab server 205 may make a remote connection to the machine that hosts the agent components and pass the configuration data to the virtualization layer which in turn makes it available inside the virtual machine.

Once the data reaches the virtual machine, a lab agent (e.g., the lab agent 236) running inside the virtual machine may read the configuration data and configure the relevant agents (e.g., the test agent 235 and the deployment agent 237) appropriately.

In another embodiment, other mechanisms such as network connections, shared memory, or other communications mechanisms may be used to transfer the configuration data to the agents. In these cases, a lab agent inside of each virtual machine in an environment may be contacted and provided with the configuration data with which to configure the other agents as appropriate.

The lab server 205 may also configure external controllers such as the one or more test controllers 210 and the one or more deployment controllers 215. To configure these external controllers, the lab server 205 may connect to each controller and configure them. As part of this configuration, the lab server 205 may bind agents running on each lab system of a lab environment to a configured external controller. This may lead to the creation of a “Deployment Environment” associated with a deployment controller and a “Test Environment” associated with a test controller.

Once the infrastructure components mentioned above are configured, health status of these components may be monitored and reported. A lab agent (e.g., the lab agent 236) may monitor health of test and deployment components installed on a lab system that hosts the lab agent. The lab agent may report the status of the test and deployment components to the lab server 205 via a data exchange component or otherwise.

Deployment of an application may include deploying different components of the application on appropriate lab systems. Components of an application may be targeted to a logical role which in turn maps to one or more lab systems.

The deployment workflow of an application may be composed such that each logical component of an application is targeted to a single logical role or user-defined tag as described below. Logical roles may map to one or more machines depending upon the environment on which the application is being deployed. For example, for a one-machine environment, all logical roles may map to a single physical machine. In a production environment, each of the logical components may map to one or more physical machines.

Similarly, the lab environments may also be composed such that each lab system has logical role(s) to play. Each lab system may be associated with one or more roles and each role may be associated with one or more lab systems. These roles may be defined by the user and include roles (e.g., Web server, database server, and so forth) previously described.

During configuration of deployment and test agents on a lab system, the lab server 205 may tag these agents with the roles associated with their owning lab system. In an embodiment, a tag may comprise text, an identifier, or the like that serves to identify or describe a role associated with a lab system. In another embodiment, a tag may be user-defined and not necessarily associated with any particular role. Tag information may be stored in a database associated with the lab server (e.g., the database 220), on lab systems, in agents (e.g., one or more of the agents 235-237), a combination of two or more of the above, and the like.

An activity in a deployment workflow may be targeted for a particular machine by specifying criteria to select the machine. The criteria can be based on a name of an agent or tags associated with the agent. Using this feature, a user may author a distributed workflow document with the deployment activities targeted for different machines in the environment to deploy the relevant components.

There are many applications for using the mechanisms described above for creating a virtual test environment. Some of these applications include:

1. Testing a multi-machine application in a nightly build. Deployment workflow may be extended to automate the process of nightly build, application deployment, running tests, and the like. A nightly build process may build an application from the latest sources. In conjunction with a nightly build of an application, a multi-machine lab Environment may be created or brought to a know state (e.g., by reverting to a snapshot). The newly built application may then be deployed in this environment and tested. This may allow developers and others to determine whether any changes made prior to the nightly build have caused errors.

2. Creating test ready environments for testers. The deployment workflow mentioned above may be extended to create multiple environments with the newly built application deployed on them after the build is successful. This would enable the team members to get access to a personal and up-to-date environment when they come to work in the morning.

3. Creating build labs. Mechanisms mentioned above allow a user to dynamically provision a virtual build lab. This may be done, for example, using a lab environment template or by bringing an existing virtual build lab to a known clean state by reverting to a snapshot. The build agents in the build lab may also be configured by the lab server the similar mechanism which is used to configure other agents. Having a virtual build lab that is in a known clean state ensures the sanity of the build lab which in turn ensures the sanity of each generated build.

4. Continuous error checking. To ensure that a change in the source code will not break a build, ALM tools may trigger a build workflow on each and every check-in of code. This build workflow may be extended to include deployment of a new application included the change and running of tests as mentioned previously.

5. Developer-ready environments. During development, to test and debug code, a developer may deploy binaries in an environment or enable debuggers on relevant machines. Mechanisms mentioned herein may be integrated with an integrated development environment (IDE) to be used to deploy a local build to a multi-machine environment and to enable debuggers.

The applications of the teachings herein mentioned above are not intended to be all-inclusive or exhaustive. Indeed, those skilled in the art may recognized many other environments in which the teachings discussed herein may be applied without departing from the spirit or scope of aspects of the subject matter described herein.

Although the environments described above includes various numbers of the entities and related infrastructure, it will be recognized that more, fewer, or a different combination of these entities and others may be employed without departing from the spirit or scope of aspects of the subject matter described herein. Furthermore, the entities and communication networks included in the environment may be configured in a variety of ways as will be understood by those skilled in the art without departing from the spirit or scope of aspects of the subject matter described herein.

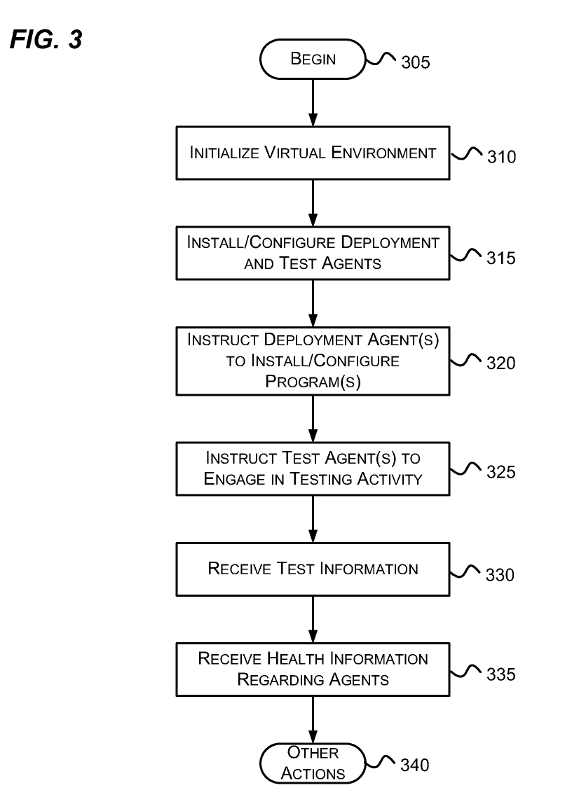

FIGS. 3-6 are flow diagrams that generally represent actions that may occur in accordance with aspects of the subject matter described herein. For simplicity of explanation, the methodology described in conjunction with FIGS. 3-6 is depicted and described as a series of acts. It is to be understood and appreciated that aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events.

FIG. 3 is a block diagram that generally represents exemplary actions that may occur in accordance with aspects of the subject matter described herein. Turning to FIG. 3, at block 305, the actions begin.

At block 310 a virtual environment is initialized. Initialization may include restoring the virtual machines of the environment to a snapshot, installing operating systems and related programs into virtual machines of the environment, uninstalling or installing programs in an existing virtual environment to revert to a state consistent with the virtual environment, other activities, and the like. For example, referring to FIG. 2, the lab environment 225 may be initialized by restoring to a snapshot.

At block 315, deployment and test agents in the environment may be installed and configured. Installing and configuring the test agents may include sending lab information to lab agents that executes inside the virtual machines. The lab information instructs the lab agents to configure their respective deployment agents and the test agents within the virtual machines. Configuring a deployment agent may include registering the deployment agent with its respective deployment controller. Similarly, configuring a test agent may include registering the test agent with its respective test controller.

At block 320, the deployment information is sent to deployment agent(s) that executes inside the virtual machines. The deployment information may instruct deployment agents to install and/or configure programs on the virtual machines. For example, referring to FIG. 2, the lab server 205 may send deployment information to the deployment agents inside the lab systems 230-232.

At block 325, test configuration information is sent to test agents that execute inside the virtual machines. The test configuration information instructs the test agent to engage in testing activity regarding the program. For example, referring to FIG. 2, the test controller 210 may send testing configuration information to the test agent 235.

At block 330, test information is received. For example, referring to FIG. 2, the test controller 210 may receive test information about a test from the test agent 235.

At block 335, health information regarding one or more agents is received. For example, referring to FIG. 3, the lab server 205 may receive health information regarding the test agent 235 and the deployment agent 237 from the lab agent 236. Note, that this information may be received at any point and may happen concurrently with other activities that may occur in a lab environment.

At block 340, other actions, if any may be performed.

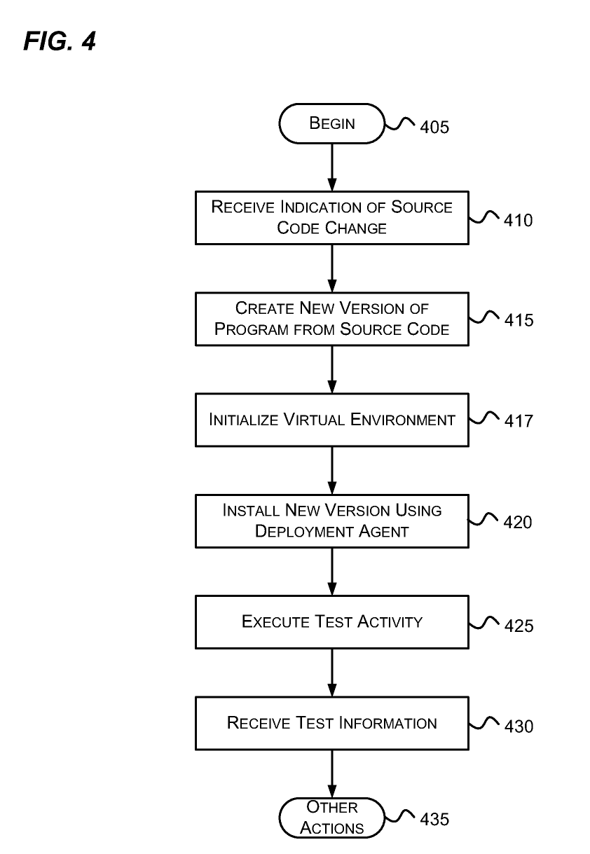

FIG. 4 is a block diagram that generally represents exemplary actions that may occur in testing a change to source code in accordance with aspects of the subject matter described herein. These exemplary actions may implement the continuous error checking described previously. At block 405, the actions begin.

At block 410, an indication that source code has changed is received. For example, a component (e.g., a build service) may receive a message that source code for a particular lab environment has changed.

At block 415, a new version of one or more programs is created based on the new source code. For example, the build service may cause that a new version of one or more programs be created from the new source code by a compiler (not shown).

At block 417, a virtual environment is initialized. Actions similar to those described in conjunction with block 310 of FIG. 3 may be performed. For example, referring to FIG. 2, the lab environment 225 may be initialized by restoring to a snapshot.

At block 420, the new version is installed using one or more deployment agents. Prior to this occurring, the virtual environment may be restored to a known (e.g., clean) state. For example, referring to FIG. 2, the deployment controller 215 may instruct one or more deployment agents to install the new version of the program.

At block 425, a test activity is executed against the new version of the program. For example, referring to FIG. 2, one or more test agents may execute a test activity with respect to the new version of the program.

At block 430, test information regarding the test activity is received. For example, referring to FIG. 2, the test controller 210 may receive test information from the one or more test agents.

At block 435, other actions, if any, may be performed.

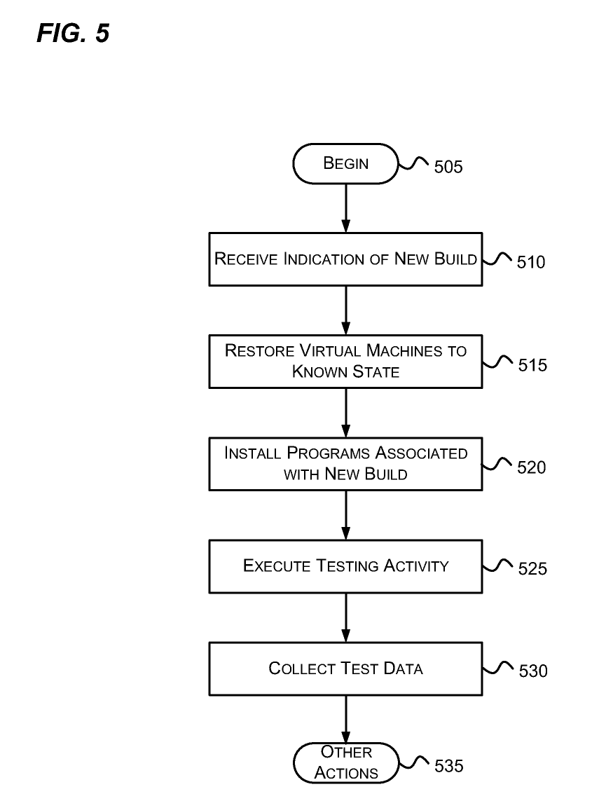

FIG. 5 is a block diagram that generally represents exemplary actions that may occur in testing a new build in accordance with aspects of the subject matter described herein. At block 505, the actions begin.

At block 510, an indication that a new build is available is received. For example, a component may receive a message that a new build is available.

At block 515, virtual machines in a lab environment may be restored to a known state. For example, referring to FIG. 2, the lab systems 230-232 in the lab environment 225 may be restored to a snapshot image.

At block 520, programs associated with the new build are installed on virtual machines associated with a lab environment. These programs may be installed according to roles associated with the virtual machines. For example, referring to FIG. 2, the deployment controller 215 may install (e.g., via deployment agent that execute in the lab systems 230-232) programs associated with the new build.

At block 525, a test activity is executed against the new programs involved in the new build. For example, referring to FIG. 2, one or more test agents may execute a test activity with respect to the new build.

At block 530, test data may be collected regarding the testing activity from deployment agents that execute in the virtual machines. For example, referring to FIG. 2, the test controller 210 may collect test information from the one or more test agents.

At block 535, other actions, if any, may be performed.

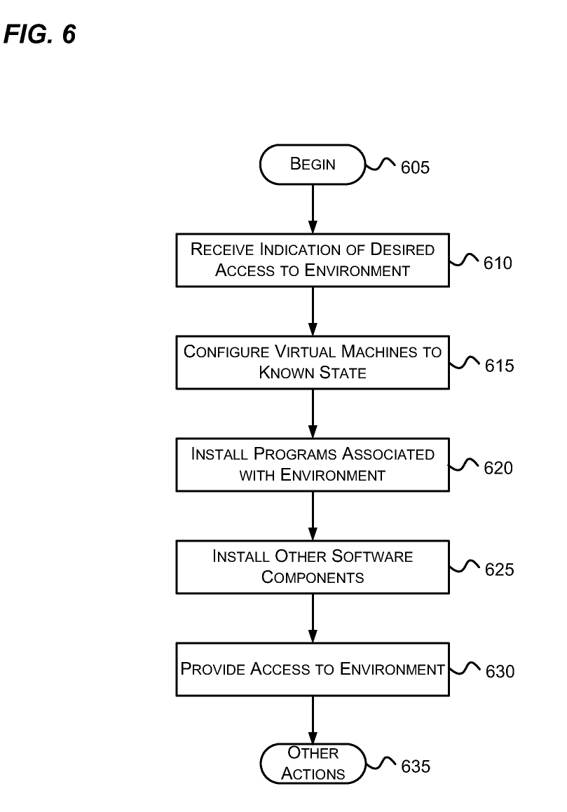

FIG. 6 is a block diagram that generally represents exemplary actions that may occur in providing access to a development tool to a virtual environment in accordance with aspects of the subject matter described herein. In one exemplary scenario, the actions described below in conjunction with blocks 610-635 may be taken to develop fixes for bugs in programs. For example, a bug report may get filed and recorded in a database. A developer seeing the bug report may want to fix the bug and make sure that the fix does not break other code.

In developing a fix for the bug, the developer may make changes to a local source tree. For development, the developer may use an integrated development environment (IDE). The IDE may be tightly integrated with a lab server such that the IDE can instruct (e.g., send messages to, call an API of, or otherwise communicate with) the lab server to set up virtual environments in which to test fixes to the bug. After the developer has developed a fix to the bug, the developer may request (e.g., via the IDE) that a virtual testing environment be set up to validate the fix.

Setting up the virtual testing environment may include initializing the environment, installing one or more binaries that include the fix, installing any binaries that interact with the one or more binaries, and installing other software components such as debuggers, loggers, other testing software, and the like. After the virtual testing environment is set up, the lab server may send a message to the IDE to indicate that the testing environment is ready to access for testing the fix.

The developer may then determine via various tests whether the fix is good and does not break other functionality in the software. If the fix is good, the developer may then check source code corresponding to the fix into a source code repository.

The scenario above is just one exemplary use of providing access to a virtual environment to a development tool. Based on the teachings herein, those skilled in the art may recognize other uses for providing access to a virtual environment to a development tool.

At block 605, the actions begin.

At block 610, an indication of desired access to an environment is received. This indication may come from a development tool such as an IDE, for example. For example, referring to FIG. 2, the lab server 205 may receive a request from an IDE (not shown) for access to the lab environment 225. The lab server 205 may be tightly integrated with the IDE such that when a developer/tester opens a project, the IDE may automatically inform the lab server 205 of the lab environment associated with the project.

At block 615, virtual machines are set up in a known state. For example, referring to FIG. 2, the lab systems 230-232 in the lab environment 225 may be restored to a snapshot image or otherwise configured to a known state.

At block 620, programs associated with the environment are installed. For example, referring to FIG. 2, the deployment controller 215 may install one or more binaries that include the fix and may also install any associated binaries with which the binaries interact in the lab systems 230-232 of the lab environment 225.

At block 625, other software components may be installed in the environment. Other software components may include debuggers, logging mechanism, and the like that are needed or desired for developing/testing in the lab environment 225. For example, referring to FIG. 2, the deployment controller 215 may install and configure other software components on the lab systems 230-232 as needed or desired.

At block 630, access to the environment is provided to the development tool. For example, referring to FIG. 2, the development tool (not shown) may be made aware of the lab environment 225 and the lab systems 230-232. Information may be given to the development tool to enable the development tool to access programs and other software components installed in the lab systems 230-232 of the lab environment 225.

At block 635, other actions, if any, may be performed.

As can be seen from the foregoing detailed description, aspects have been described related to test-ready virtual environments. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A method implemented at least in part by a computer, the method comprising:
initializing a virtual environment that includes one or more virtual machines;
sending deployment information to a deployment agent that executes inside of one of the virtual machines, the deployment information instructing the deployment agent to configure a program on the one of the virtual machines; and
sending test configuration information to a test agent that executes inside the one of the virtual machines, the test configuration information instructing the test agent to engage in a testing activity regarding the program.

2. The method of claim 1, further comprising determining the one of the virtual machines based on a tag associated with the deployment agent.

3. The method of claim 1, wherein initializing a virtual environment that includes one or more virtual machines comprises restoring the virtual environment from a snapshot.

4. The method of claim 1, further comprising instructing the deployment agent to install the program on the one of the virtual machines.

5. The method of claim 1, further comprising sending lab information to a lab agent that executes inside the one of the virtual machines, the lab information instructing the lab agent to configure the deployment agent and the test agent within the one of the virtual machines.

6. The method of claim 1, further comprising receiving health information regarding the deployment agent and the test agent from a lab agent that executes inside the one of the virtual machines.

7. The method of claim 1, further comprising:
receiving an indication of a change in source code associated with the program;
creating a new version of the program based source code as changed;
installing the new version of the program using the deployment agent;
executing the testing activity using the new version of the program;
receiving test information regarding the testing activity from the test agent.

8. The method of claim 1, further comprising:
receiving an indication that a new build that includes the program is available;
restoring the virtual machines to a known state;
installing, via deployment agents that execute in the virtual machines, programs associated with the new build on the virtual machines according to roles associated with the virtual machines;
executing other testing activity that involves the programs installed on the virtual machines;
collecting test data regarding the other testing activity from deployment agents that execute in the virtual machines.

9. The method of claim 1, further comprising:
receiving, from a development tool, an indication to access the program from the development tool;
setting up the virtual machines in a known state;
installing, via the deployment agent, the program on the one of the virtual machines;
installing, via deployment agents executing on the virtual machines, software components associated with the program; and
providing access to the program and software components to the development tool.

10. A computer storage medium having computer-executable instructions, which when executed perform actions, comprising:
creating a virtual environment that includes one or more virtual machines;
installing a set of one or more programs inside the one or more virtual machines via a set of one or more deployment agents that execute inside the one or more virtual machines, at least some of the set of programs operable to communicate with each other within the virtual environment; and
configuring the set of one or more programs via the set of one or more deployment agents.

11. The computer storage medium of claim 10, wherein installing a set of one or more programs inside the one or more virtual machines comprises installing build agents operable to build one or more binaries from source code.

12. The computer storage medium of claim 11, further comprising instructing agents executing on the one or more virtual machines to configure the build agents to build the one or more binaries from the source code.

13. The computer storage medium of claim 10, further comprising, in response to a nightly build that involves the set of one or more programs, creating multiple copies of the virtual environment with the set of programs installed and configured within the copies and providing access to the multiple copies of the virtual environment at least to one user responsible for testing the set of one or more programs.

14. The computer storage medium of claim 10, further comprising configuring a set of test agents to obtain test information regarding the set of one or more programs, the set of test agents operable to execute inside the one or more virtual machines.

15. The computer storage medium of claim 14, further comprising receiving health information from lab agents that execute inside the one or more virtual machines, the health information indicating health of the deployment agents and the test agents.

16. In a computing environment, a system, comprising:
a set of one or more virtual machines operable to provide an environment for executing programs inside the virtual machines, at least two of the programs operable to communicate with each other during execution;
a deployment controller operable to manage one or more deployment agents, the deployment agents operable to execute inside the virtual machines, each deployment agent associated with a different virtual machine, each deployment agent operable to execute a deployment activity with respect to the deployment agent's associated virtual machine upon request from the deployment controller; and
a test controller operable to manage a set of one or more test agents, the test agents operable to execute inside the virtual machines, each test agent associated with a different virtual machine, each test agent operable to execute a testing activity with respect to the test agent's associated virtual machine upon request from the test controller.

17. The system of claim 16, further comprising a lab server operable to send configuration data to the deployment controller, the test controller, the deployment agents, and the test agents and to bind the deployment agents to the deployment controller and the test controller to the test agents.

18. The system of claim 16, wherein two or more of the set of one or more virtual machines are hosted on a single physical machine.

19. The system of claim 16, further comprising a set of lab agents, each lab agent operable to execute in a different virtual machine of the virtual machines, each lab agent further operable to monitor health of any test agent and deployment agent installed in the different virtual machine on which the lab agent executes.

20. The system of claim 19, wherein each lab agent is further operable to install and configure the test agent and deployment agent in the different virtual machine on which the lab agent executes.
